(19) United States
(12) Patent Application Publication
(10) Pub. No.: US 2025/0182270 A1
(43) Pub. Date: Jun. 5, 2025

(54) AUTOMATED LUMEN AND VESSEL SEGMENTATION IN ULTRASOUND IMAGES

(71) Applicants: MEDSTAR HEALTH, INC., Columbia, MD (US); NATIONAL LABORATORY FOR SCIENTIFIC COMPUTING, Rio de Janeiro (BR); FLOUIT, INC., Middletown, DE (US)

(72) Inventors: Hector M. Garcia-Garcia, Columbia, MD (US); Pablo J. Blanco, Buenos Aires (BR); Gonzalo D. Ares, Middletown, DE (US); Paulo G.P. Ziemer, Rio de Janeiro (BR); Gonzalo D. Maso Talou, Rio de Janeiro (BR)

(21) Appl. No.: 18/684,268

(22) PCT Filed: Jun. 29, 2022
(86) PCT No.: PCT/US2022/035514

§ 371 Date: Feb. 16, 2024

Related U.S. Application Data
(60) Provisional application No. 63/216,283, filed on Jun. 29, 2021.

(51) Int. Cl. G06T 7/00; G06T 7/12

(52) U.S. Cl. CPC G06T 7/0012; G06T 7/12; G06T 2207/10132; G06T 2207/20084; G06T 2207/30101

(57) ABSTRACT

Systems and methods are provided for intravascular imaging. A plurality of intravascular images representing a blood vessel of a patient are acquired and each of a subset of the plurality of images are provided to a convolutional neural network to provide a set of candidate segmentations of either or both of a lumen boundary and a vessel boundary associated with the blood vessel. The set of candidate segmentations are to a regression model to produce contours of the lumen and vessel boundaries.

### RELATED APPLICATIONS

This application claims priority to U.S. Provisional Patent No. 63/216,283, filed Jun. 29, 2021 and entitled “Automated Lumen and Vessel Segmentation in Ultrasound Images,” which is hereby incorporated by reference in its entirety.

### TECHNICAL FIELD

This invention relates to medical imaging, and more particularly, to automated lumen and vessel segmentation in ultrasound images.

### BACKGROUND

Intravascular ultrasound (IVUS) is the gold standard imaging modality for the assessment of coronary artery disease. Intravascular ultrasound provides a highly detailed view of the inner coronary structure, such as lumen, external elastic membrane (EEM, or “vessel”), and plaque. One of the most arduous tasks when analyzing IVUS datasets is the delineation, or segmentation, of the lumen boundary and EEM, for which an expert has to manually outline them. This process is performed either one frame at a time using transversal contouring or at the dataset level by tracing a small number of longitudinal cutting planes. Given the large intra-observer and inter-observer variability for drawing tasks and its time-consuming nature, the translation of this procedure to online diagnosis pipelines is hindered and unreliable.

### SUMMARY OF THE INVENTION

In one implementation, a method is provided for intravascular imaging. A plurality of intravascular images representing a blood vessel of a patient are acquired and each of a subset of the plurality of images are provided to a convolutional neural network to provide a set of candidate segmentations of either or both of a lumen boundary and a vessel boundary associated with the blood vessel. The set of candidate segmentations are to a regression model to produce contours of the lumen and vessel boundaries.

In another implementation, a system is provided for intravascular imaging. The system includes an intravascular imaging device that acquires a plurality of intravascular images representing a blood vessel of a patient. A convolutional neural network receives a subset of the plurality of images from the intravascular imaging device and provides a set of candidate segmentations of either or both of a lumen boundary and a vessel boundary associated with the blood vessel. A regression model produces a contour from the set of candidate segmentations.

In a further implementation, a system is provided for intravascular imaging. The system includes a convolutional neural network that receives a set of images from an intravascular imaging device and provides a set of candidate segmentations of either or both of a lumen boundary and a vessel boundary associated with the blood vessel. The convolutional network provides a candidate segmentation for a given image from the image and a set of neighboring images. A Gaussian process regression model that produces a contour from the candidate segmentations.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 illustrates one example of a system for segmenting ultrasound images of a blood vessel;

FIG. 2 illustrates a system for segmenting a time series of images taken from an intravascular ultrasound device;

FIG. 3 illustrates a method for segmenting lumen and vessel boundaries in a blood vessel;

FIG. 4 illustrates another method for segmenting lumen and vessel boundaries; and

FIG. 5 is a schematic block diagram illustrating an exemplary system of hardware components capable of implementing examples of the systems and methods disclosed herein.

### DETAILED DESCRIPTION

In the context of the present disclosure, the singular forms “a,” “an” and “the” can also include the plural forms, unless the context clearly indicates otherwise. The terms “comprises” and/or “comprising,” as used herein, can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

Additionally, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “substantially identical” or “substantially equal” refers to articles or metrics that are identical other than measurement error.

As used herein, an “intravascular image” is an image that includes an interior of a blood vessel. Such images can be produced, for example, via intravascular ultrasound (IVUS) or optical coherence tomography (OCT).

The systems and methods described herein provide an automated workflow to segment lumen and vessel boundaries in intravascular image datasets using a machine learning (ML) approach. The focus is on lumen and vessel segmentation due to its clinical relevance in the definition of minimum lumen area (MLA), in the definition of percentage area of stenosis, and in the definition of plaque burden, which are features used for clinical decision making, for example, determining if a given lesion must be treated. The proposed pipeline performs lumen and vessel boundary segmentation using a convolutional neural network and further refinement of lumen and vessel contours through a regression algorithm, such as a Gaussian Process (GP) regression.

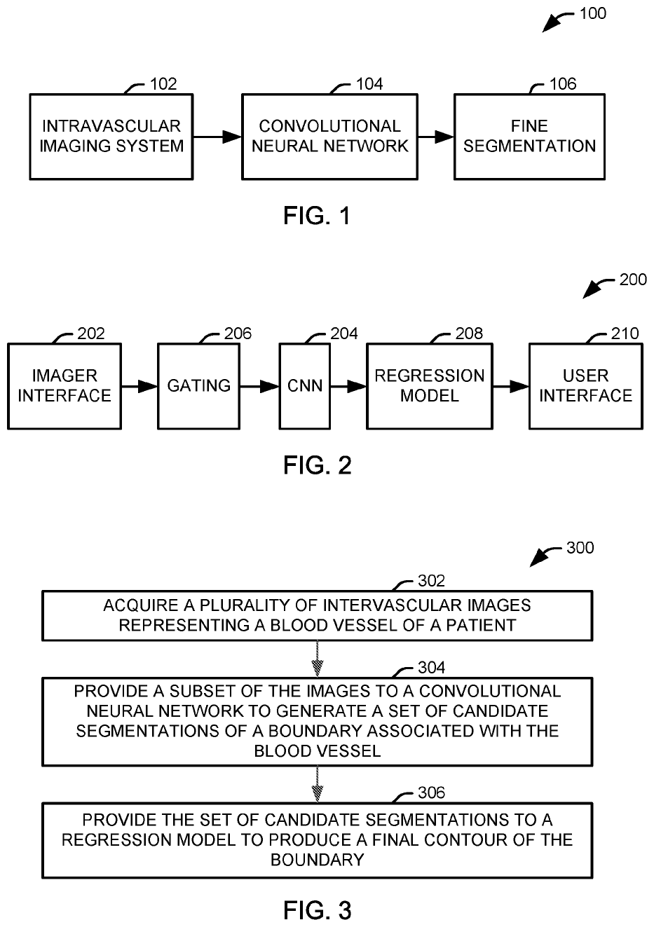

FIG. 1 illustrates one example of a system 100 for segmenting ultrasound images of a blood vessel. An intravascular imaging device 102 is configured to capture intravascular images. For example, the intravascular device can include an ultrasound probe mounted on a tip of a catheter that captures images while positioned within the blood vessel or an OCT imager. In the ultrasound implementation, a series of images can be captured at regular intervals while the catheter tip is slowly translated through the vessel, whereas the OCT device naturally provides a series of two-dimensional slices representing a three-dimensional region of interest. In one implementation, each of the two-dimensional slices is mapped into polar coordinates for further analysis, with a resolution of 256×256 pixels. The captured images are provided to a convolutional neural network (CNN) 104 for an initial segmentation. The convolutional neural network can be implemented, for example, using a U-Net architecture. Some or all of the layers of the convolutional neural network 104 can be trained on a set of training images that have been segmented by human experts. The output of the convolutional neural network 104 for each image is a candidate

The output of the convolutional neural network is a high-frequency image that may contain intrinsic noise resulting from a large number of degrees of freedom within the image domain. Moreover, in some cases, the output is not devoid of holes and isles, which hinders the straightforward definition of lumen and vessel. The segmented polar image is not periodic in general, as no geometrical or shape prior is explicitly given to the loss employed in training the convolutional neural network to constrain the outputs. Accordingly, the candidate segmentations across the series of images are provided to a fine segmentation component 106 that produces a final segmentation for one or both of the lumen and vessel boundaries. The fine segmentation component 106 employs a regression model to simultaneously filter out high-frequency noise and to produce a periodic lumen and/or vessel contour from the candidate segmentations for the series of images.

FIG. 2 illustrates a system 200 for segmenting a time series of images taken from an intravascular ultrasound (IVUS) device. The system 200 can be implemented as software or firmware instructions stored on a non-transitory computer readable medium and executed by an associated processor, dedicated hardware, such as a field programmable gate array or an application specific integrated circuit, or as a combination of software and firmware instructions. The system 200 includes an imager interface 202 that receives the time series of images and conditions the image data for analysis at a convolutional neural network (CNN) 204. It will be appreciated that the time series of images can be taken at constant intervals during a pullback process in intravascular ultrasound effectively represent evenly spaced locations along the length of the blood vessel.

In one example, the convolutional neural network 204 is trained on a set of images that have been segmented by a human expert. In one example, a set of electrocardiogram (ECG)-synchronized images, indicating the end-diastolic frames, can be captured for each of a plurality of patients, for example, while a catheter is translated through a blood vessel. The number of end-diastolic frames per patient can be augmented, where necessary, to a standard number of frames (e.g., two hundred eighty-two) via interpolation between end-diastolic frames where needed. In this example, ground truth segmentations were manually generated by an expert, and the annotation procedure includes manual delineation of the lumen contour in four longitudinal planes from the gated dataset, located at forty-five degrees from each other. The lumen contour is then defined through a cubic spline interpolation through these points. Frames with side branches or where the vessel is partially out of the field of view were excluded from the test dataset used to assess the segmentation performance. The resulting frames were used both for training the neural network model and to evaluate its performance.

In one example, the convolutional neural network 204 comprises blocks with two convolutional layers, each of them followed by an activation layer. The activation layer can use any appropriate activation function include a linear function, a sigmoid function, a hyperbolic tangent, a rectified linear unit (RELU), or a softmax function. In this example, the convolutional neural network 204 includes consecutive encoding/decoding blocks with two convolutional layers, each with three-by-three filters, and batch normalization. Two-by-two max-pooling operations were used in an encoding path to downsample the feature maps resolution, while bilinear upsampling operations followed by convolutional blocks were applied in a decoding path to recover the original image size. Thirty-two, sixty-four, and one hundred twenty-eight filters, respectively, were used for the three encoding blocks, and one hundred twenty-eight, sixty-four and thirty-two filters, respectively, were used for the three decoding blocks.

The convolutional neural network 204 uses a multi-frame input stack, which allows it to evaluate each intravascular ultrasound frame not as a single ultrasound frame, but in the context of its neighboring frames. This is achieved by including each neighboring frame as an additional input channel to the frame under consideration. Adding neighbors in the spirit of a multi-channel image increments the coherence among frames, under the assumption that neighboring frames should render a similar lumen structure and, therefore, similar segmentations. In one example, the convolutional neural network was trained for fifty epochs by optimizing the categorical cross-entropy loss using Adam optimization with a batch size of six multi-frame stacks and 17000 iterations per epoch. The initial learning rate was fixed to 0.001 and decreased by a factor of 0.5 after twenty-five epochs.

A subset of the time series of images can be selected via a gating component 206. Throughout the time series, a saw-tooth artifact is usually observed, representing a change in the vessel pressure during the cardiac cycle, which hinders the longitudinal analysis of the IVUS images. In some implementations, electrocardiogram (ECG)-synchronized images can be captured to avoid this artifact, but such images are not always available. Thus, a consistent and accurate alternative is required to select the end-diastolic frames automatically. To this end, the gating component 206 can identify a subset of the time series of images representing images taken at a same cardiac phase in the cardiac cycle.

In one implementation, the gating component 206 selects the images by locating the minimum of a motion signal constructed by a combination of inter-frame inverse correlation and intra-frame intensity gradients and selecting the frames associated with the minimum of the motion signal as representing the end of the diastolic portion of the cardiac cycle. For each image in the set of images, a signal is computed as a convex combination of two normalized signals: the inverse correlation between consecutive images and a measure of blurring based on the integration of the intensity gradients. End-diastolic frames correspond to a specific set of minima in the motion signal. However, as this signal features many local minima per cardiac cycle, additional processing is performed to determine the true cardiac cycles, and thus the minimum of each cycle. A harmonic decomposition of the signal is performed, and the frequencies in which the heart rate can range, assuming no arrhythmias, are selected. The signal for each cardiac cycle is then decomposed into the first fifteen harmonics. The first harmonic is used to perform a coarse location of the global minimum, and with the incremental addition of each subsequent harmonic, the location of the minimum can be refined from this initial value. The best parameter in the convex combination of the is optimally and automatically selected at a patient-specific level by searching the parameter that minimizes the standard deviation of the patient's heart rate, which was identified with the first harmonic. Once the images are selected, they are provided to the convolutional neural network 204 for analysis.

The convolutional neural network 204 is trained to evaluate the images in sets, referred to herein as stacks, such that the segmentation of each image is performed in the context of neighboring images. In one example, the stacks of images can include sets of between one (single frame scenario) and eleven images, with the stack including the image under consideration and between zero and five pairs of neighboring images arranged symmetrically around the image under consideration. For each image, the stack of images associated with the image is input into the convolutional network as separate channels, and a candidate segmentation for the image is output. In one example, the stack of images is given in a system of coordinates in which each point is determined by a distance from a center point and an angle from a reference direction (i.e., as polar coordinates), and the output candidate segmentation, also represented in polar coordinates, is a multi-class (e.g., three classes) segmentation.

Once all of the images have been segmented, the candidate segmentations are passed to a regression model 208 that has been trained on a set of vessel or lumen segmentations performed by a human expert. The output of the multi-frame CNN 204 is a high-frequency image that may contain intrinsic noise resulting from a large number of degrees of freedom within the image domain. In some cases, the output includes holes and isles, which hinders the straightforward definition of the lumen. The segmented polar image is not periodic in general, as no geometrical or shape prior is explicitly given to the loss employed in training the CNN 204 to constrain the outputs. The regression model 208 simultaneously filters out high-frequency noise and to produce a periodic lumen contour. In the illustrated example, the regression model 208 includes a Gaussian process regression model that uses an exponential sine squared kernel function with a fixed periodicity parameter, based on the horizontal size of the polar image, and with a length scale parameter learned for each image through a fully automated optimization procedure with a fixed one-fits-all noise parameter. The final segmentation can then be displayed to a user at an associated display (not shown) via a user interface 210.

The proposed system 200 provides a number of advantages. Adding information about neighboring frames surrounding the frame of interest consistently improved the segmentation performance at the CNN 204. Moreover, the use of the regression model 208 improved the resulting segmentation by dealing with high-frequency noise and enforcing contour continuity (periodicity) of the lumen boundary, yielding anatomically coherent lumen delineations. The combination of automatic gating, multi-frame convolutional neural network segmentation, and regression provides a consistent and reliable framework to account for the longitudinal and transversal coherence encountered in intravascular ultrasound datasets. In the catheterization laboratory, minimum lumen areas are commonly used to inform the clinical decision whether the lesion requires revascularization particularly in the left main coronary artery. Currently, this assessment is performed by visually inspecting the pullback and selecting what by eye seems to be the smallest lumen area, which then by manual tracing a number is obtained representing the minimum lumen area. This approach assumes that by visual inspection of the pullback the right frame is selected (i.e., represents the smallest lumen in that lesion) and that the manual tracing of the lumen is properly done. Unfortunately, there is a large variability in the selection of the minimum lumen area frame and in the tracings of the lumen area. More importantly, this is time-consuming and demands adequately trained personnel. The illustrated system overcomes all these issues by providing a fast, accurate, and precise assessment of the lumen areas.

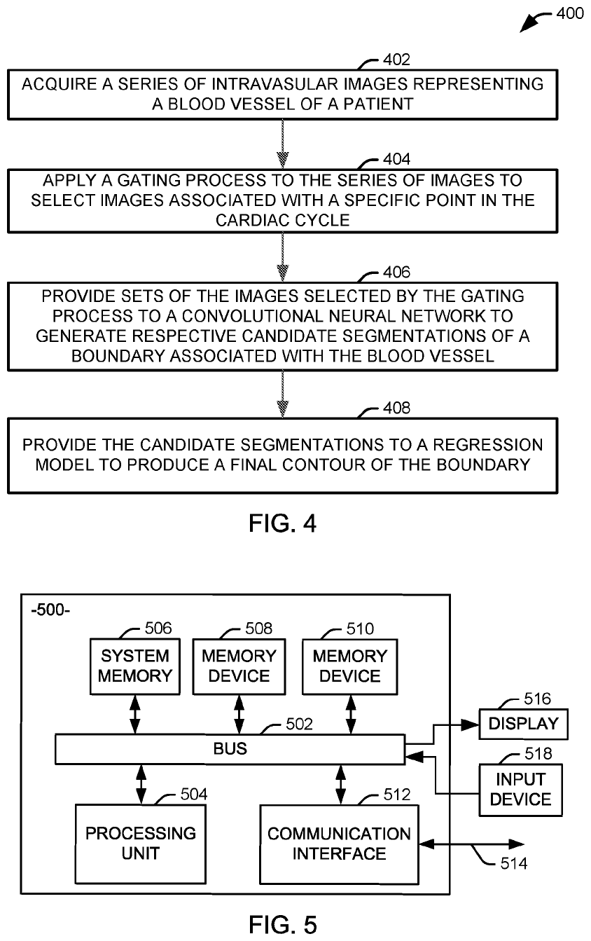

In view of the foregoing structural and functional features described above, example methods will be better appreciated with reference to FIGS. 3 and 4. While, for purposes of simplicity of explanation, the example methods of FIGS. 3 and 4 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 3 illustrates a method 300 for segmenting lumen and vessel boundaries in a blood vessel. At 302, a plurality of intravascular images are acquired. The images can be captured, for example, as part of a “pullback” procedure in which a catheter containing an ultrasound device is slowly translated through the blood vessel at a known rate, such that each image represents a known location in the blood vessel. Alternatively, the plurality of images can be two-dimensional slices taken of a three-dimensional region of interest at an OCT imager. At 304, each of a subset of the plurality of images are provided to a convolutional neural network to provide a set of candidate segmentations of either or both of the lumen and vessel boundaries associated with the blood vessel. For example, the subset of the plurality of images can be selected to include images representing a designated point in the cardiac cycle. At 306, the set of candidate segmentations are provided to a regression model to produce a final contour of either or both of the lumen and vessel boundaries. In one implementation, the regression model is a Gaussian regressor that removes high-frequency noise from the boundaries, ensuring that the final lumen and vessel contours are both continuous and smooth.

FIG. 4 illustrates another method 400 for segmenting lumen and vessel boundaries. At 402, a series of intravascular images are acquired at an ultrasound device positioned within a blood vessel of a patient. At 404, a gating process is applied to the series of images to select images associated with a specific point in the cardiac cycle. In one implementation, the specific point in the cardiac cycle is the end of the diastolic stage. At 406, sets of the images selected by the gating process are provided to a convolutional neural network to generate respective candidate segmentations of either or both of the lumen and vessel boundaries associated with the blood vessel. Each set of images includes an image to be segmented as well as pairs of neighboring images on either side of the image from the series of images. At 408, the set of candidate segmentations are provided to a regression model to produce a final contour of either or both of the lumen and vessel boundaries.

FIG. 5 is a schematic block diagram illustrating an exemplary system 500 of hardware components capable of implementing examples of the systems and methods disclosed herein. The system 500 can include various systems and subsystems. The system 500 can be a personal computer, a laptop computer, a workstation, a computer system, an appliance, an application-specific integrated circuit (ASIC), a server, a server BladeCenter, a server farm, etc.

The system 500 can include a system bus 502, a processing unit 504, a system memory 506, memory devices 508 and 510, a communication interface 512 (e.g., a network interface), a communication link 514, a display 516 (e.g., a video screen), and an input device 518 (e.g., a keyboard, touch screen, and/or a mouse). The system bus 502 can be in communication with the processing unit 504 and the system memory 506. The additional memory devices 508 and 510, such as a hard disk drive, server, standalone database, or other non-volatile memory, can also be in communication with the system bus 502. The system bus 502 interconnects the processing unit 504, the memory devices 506-510, the communication interface 512, the display 516, and the input device 518. In some examples, the system bus 502 also interconnects an additional port (not shown), such as a universal serial bus (USB) port.

The processing unit 504 can be a computing device and can include an application-specific integrated circuit (ASIC). The processing unit 504 executes a set of instructions to implement the operations of examples disclosed herein. The processing unit can include a processing core.

The additional memory devices 506, 508, and 510 can store data, programs, instructions, database queries in text or compiled form, and any other information that may be needed to operate a computer. The memories 506, 508 and 510 can be implemented as computer-readable media (integrated or removable), such as a memory card, disk drive, compact disk (CD), or server accessible over a network. In certain examples, the memories 506, 508 and 510 can comprise text, images, video, and/or audio, portions of which can be available in formats comprehensible to human beings. Additionally or alternatively, the system 500 can access an external data source or query source through the communication interface 512, which can communicate with the system bus 502 and the communication link 514.

In operation, the system 500 can be used to implement one or more parts of a system in accordance with the present invention. Computer executable logic for implementing the diagnostic system resides on one or more of the system memory 506, and the memory devices 508 and 510 in accordance with certain examples. The processing unit 504 executes one or more computer executable instructions originating from the system memory 506 and the memory devices 508 and 510. The term “computer readable medium” as used herein refers to a medium that participates in providing instructions to the processing unit 504 for execution. This medium may be distributed across multiple discrete assemblies all operatively connected to a common processor or set of related processors.

Implementation of the techniques, blocks, steps, and means described above can be done in various ways. For example, these techniques, blocks, steps, and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on.

What is claimed is:

1. A method comprising:
acquiring a plurality of intravascular images representing a blood vessel of a patient;
providing each of a subset of the plurality of images to a convolutional neural network to provide a set of candidate segmentations of one of a lumen boundary and a vessel boundary associated with the blood vessel; and
providing the set of candidate segmentations to a regression model to produce a contour of the one of the lumen boundary and the vessel boundary.

2. The method of claim 1, wherein providing each of a subset of the plurality of images comprises applying a gating process to the images to select images associated with a specific point in the cardiac cycle.

3. The method of claim 2, wherein the specific point in the cardiac cycle is the end of the diastolic stage.

4. The method of claim 1, wherein providing each of a subset of the plurality of images to a convolutional neural network comprises providing, for each of the subset of the plurality of images, the image and a set of neighboring images from the subset of the plurality of images to the convolutional neural network, such that a candidate segmentation of the set of candidate segmentations associated with the image is generated from the image and the set of neighboring images.

5. The method of claim 1, wherein the regression model is a Gaussian process regression model.

6. The method of claim 1, wherein the one of the lumen boundary and the vessel boundary is the lumen boundary.

7. The method of claim 1, wherein the one of the lumen boundary and the vessel boundary is the vessel boundary.

8. The method of claim 1, wherein the set of candidate segmentations includes both the lumen boundary and the vessel boundary.

9. The method of claim 1, wherein acquiring the plurality of intravascular images representing the blood vessel of a patient comprises acquiring the plurality of intravascular images as a series of images captured at regular intervals from the catheter tip while the catheter tip is slowly translated through the vessel.

10. A system comprising:
an intravascular imaging device that acquires a plurality of intravascular images representing a blood vessel of a patient;
a convolutional neural network that receives a subset of the plurality of images from the intravascular imaging device and provides a set of candidate segmentations of one of a lumen boundary and a vessel boundary associated with the blood vessel; and
a regression model that produces a contour of the one of the lumen boundary and the vessel boundary.

11. The system of claim 10, further comprising a gating component that applies a gating process to the images to select images associated with a specific point in the cardiac cycle.

12. The system of claim 11, wherein the specific point in the cardiac cycle is the end of the diastolic stage.

13. The system of claim 10, wherein the convolutional neural network provides a candidate segmentation of the set of candidate segmentations associated with the image from the image and a set of neighboring images.

14. The system of claim 10, wherein the convolutional neural network comprises a series of blocks comprising two convolutional layers, each followed by an activation layer.

15. The system of claim 10, wherein the regression model is a Gaussian process regression model.

16. The system of claim 15, wherein the Gaussian process regression model uses an exponential sine squared kernel function with a fixed periodicity parameter, based on the horizontal size of the polar image, and with a length scale parameter learned for each image through a fully automated optimization procedure.

17. The system of claim 10, wherein the intravascular imaging device is an optical coherence tomography imager.

18. The system of claim 10, wherein the intravascular imaging device is an ultrasound transducer.

19. A system comprising:
a convolutional neural network that receives a set of images from an intravascular imaging device and provides a set of candidate segmentations of one of a lumen boundary and a vessel boundary associated with the blood vessel, the convolutional network providing a candidate segmentation of the set of candidate segmentations associated with a given image from the image and a set of neighboring images; and
a Gaussian process regression model that produces a contour of the one of the lumen boundary and the vessel boundary.

20. The system of claim 19, further comprising a gating component that applies a gating process to the images to select images associated with a specific point in the cardiac cycle.
